(19) United States
(12) Patent Application Publication
(10) Pub. No.: US 2016/0093235 A1
(43) Pub. Date: Mar. 31, 2016

(54) Toilet paper with printed teaching aids

(71) Applicant: Paulo Alves Junqueira, Mount Vernon, NY (US)

(72) Inventor: Paulo Alves Junqueira, Mount Vernon, NY (US)

(21) Appl. No.: 14/864,516

(22) Filed: Sep. 24, 2015

Related U.S. Application Data
(60) Provisional application No. 62/055,148, filed on Sep. 25, 2014.

(51) Int. Cl. G09F 11/08; G09F 11/29; G09B 19/00; G09B 17/00; G09B 19/02

(52) U.S. Cl. CPC G09F 11/08; G09B 17/00; G09B 19/02; G09B 19/0023; G09B 19/00; G09F 11/29

(57) ABSTRACT

Toilet paper with printed teaching aids provides printed teaching aids to help very young children learn the alphabet, colors, numbers, and simple arithmetic and reading lessons. The toilet paper may provide a range of age appropriate teaching aids, such as a roll of colors for toddlers, a roll of letters and numbers for preschoolers, a roll of simple reading words for first graders, and a roll of simple arithmetic and reading rhymes for second graders.

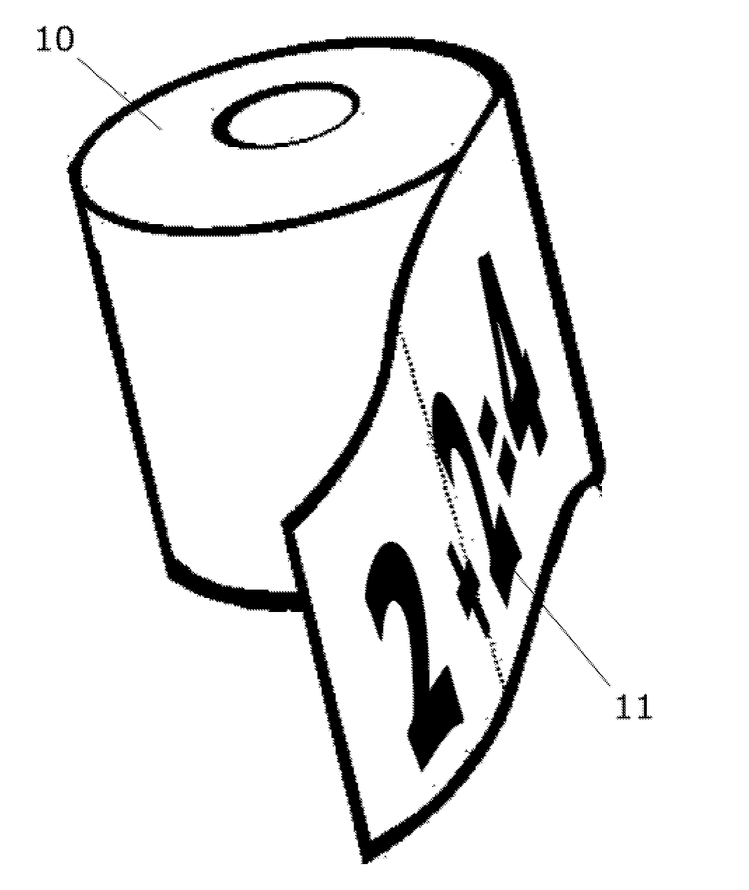

### CROSS-REFERENCE TO RELATED APPLICATIONS

This Application claims the benefit of U.S. Provisional Application No. 62/055,148, filed Sep. 25, 2014, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to teaching aids and in particular to toilet paper with printed teaching aids. Flash cards and similar visual devices have proven to be very effective in teaching young children the fundamentals of various subjects, such as the alphabet, colors, numbers, and simple arithmetic and reading lessons. This manner of teaching could be effectively combined with the process of toilet training. Some parents feel that since very young children spend a significant amount of time seated on a potty chair, they should spend the time constructively. Toilet paper with printed teaching aids, providing simple, colorful lessons for children to review while in the bathroom, would satisfy this demand.

### SUMMARY OF THE INVENTION

Accordingly, the invention is directed to toilet paper with printed teaching aids. The toilet paper provides printed teaching aids to help very young children learn the alphabet, colors, numbers, and simple arithmetic and reading lessons. The toilet paper may provide a range of age appropriate teaching aids, such as a roll of colors for toddlers, a roll of letters and numbers for preschoolers, a roll of simple reading words for first graders, and a roll of simple arithmetic and reading rhymes for second graders.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWING

The accompanying drawing is included to provide a further understanding of the invention and is incorporated into and constitutes a part of the specification. It illustrates one embodiment of the invention and, together with the description, serves to explain the principles of the invention.

The FIGURE shows a side perspective view of the first exemplary embodiment, displaying the toilet paper 10, and the teaching aid 11.

### DETAILED DESCRIPTION OF THE INVENTION

Referring now to the invention in more detail, the invention is directed to toilet paper 10 with printed teaching aids 11.

The first exemplary embodiment is comprised of a roll of toilet paper 10 which provides printed teaching aids 11 to help very young children learn the alphabet, colors, numbers, and simple arithmetic and reading lessons. The toilet paper 10 may provide a range of age appropriate teaching aids 11, such as a roll of colors for toddlers, a roll of letters and numbers for preschoolers, a roll of simple reading words for first graders, and a roll of simple arithmetic and reading rhymes for second graders. Preferably, each roll of toilet paper 10 is packaged separately. Alternately, a plurality of rolls of toilet paper 10 designed for a single age group, such as four rolls with teaching aids 11 for toddlers, may be provided in a single package.

To use the first exemplary embodiment, the adult user unwraps the roll of toilet paper 10 from its package and displays it in a bathroom, where one or more young children will read the teaching aids 11.

The toilet paper 10 is preferably manufactured from a flexible, disposable material, such as paper. Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A toilet paper with printed teaching aids, comprising:
(a) a roll of toilet paper;
(b) teaching aids;
(c) said teaching aids being printed on a surface of said roll of toilet paper;
(d) said teaching aides being appropriate for a specific age range;
(e) said roll of toilet paper being individually packaged; and
(f) said toilet paper indicating the specific age range on said package.

2. The toilet paper with printed teaching aids of claim 1, wherein said teaching aids are appropriate for toddlers.

3. The toilet paper with printed teaching aids of claim 2, wherein said teaching aids are colors.

4. The toilet paper with printed teaching aids of claim 1, wherein said teaching aids are appropriate for preschool students.

5. The toilet paper with printed teaching aids of claim 4, wherein said teaching aids are letters.

6. The toilet paper with printed teaching aids of claim 4, wherein said teaching aids are numbers.

7. The toilet paper with printed teaching aids of claim 1, wherein said teach aids are appropriate for first grade students.

8. The toilet paper with printed teaching aids of claim 7, wherein said teaching aids are simple reading words.

9. The toilet paper with printed teaching aids of claim 1, wherein said teaching aids are appropriate for second grade students.

10. The toilet paper with printed teaching aids of claim 9, wherein said teaching aids are simple arithmetic.

11. The toilet paper with printed teaching aids of claim 9, wherein said teaching aids are reading rhymes.
